(19) United States
(12) Patent Application Publication
(10) Pub. No.: US 2006/0212929 A1
(43) Pub. Date: Sep. 21, 2006

(54) Method and technique for gathering signal intelligence of all radio communications only originating from specific selected areas

(76) Inventor: Lars Karlsson, Santa Clara, CA (US)

Correspondence Address: KENYON & KENYON LLP, 1500 K STREET N.W., SUITE 700, WASHINGTON, DC, 20005, US

(21) Appl. No.: 11/201,144

(22) Filed: Aug. 11, 2005

Related U.S. Application Data
(60) Provisional application No. 60/600,657, filed on Aug. 11, 2004.
(60) Provisional application No. 60/600,642, filed on Aug. 11, 2004.
(60) Provisional application No. 60/600,641, filed on Aug. 11, 2004.
(60) Provisional application No. 60/600,643, filed on Aug. 11, 2004.

(51) Int. Cl. H04L 9/32

(52) U.S. Cl. 726/4

(57) ABSTRACT

Systems and methods of collecting intelligence provide a local intelligence system having a front end, a post-processing stage and a geolocation module. The front end may generate digital data based on received RS signals, where the post processing stage may process the digital data. The geolocation module is able to prevent the post processing stage from processing a first portion of the digital data that corresponds to RS signals originating from a geographic location other than a predetermined geographic location. In one embodiment, the geolocation module uses remote geolocation data and local geolocation data.

The present application claims priority to U.S. Provisional Patent Application No. 60/600,657 filed on Aug. 11, 2004, incorporated herein by reference, U.S. Provisional Patent Application No. 60/600,642, filed on Aug. 11, 2004, incorporated herein by reference, U.S. Provisional Patent Application No. 60/600,641, filed on Aug. 11, 2004, incorporated herein by reference, and U.S. Provisional Patent Application No. 60/600,643, filed on Aug. 11, 2004, incorporated herein by reference.

### CROSS-REFERENCE TO RELATED APPLICATIONS

The present application is related to the U.S. patent application entitled “Improved Method and Signal Intelligence Collection System that Reduces Output Data Overflow in Real-Time” and filed on even date herewith.

### BACKGROUND

1. Technical Field

Certain embodiments of the present application generally relate to intelligence collection systems. In particular, some embodiments relate to intelligence systems that use signal origin as a discriminator.

2. Discussion

Present day military-grade signal collection and surveillance equipment is used to capture communications transmissions from enemy radios and/or clandestine sources. The interception of various wireless communications is a critical signal intelligence function that is vital for national security interests. The captured signals and raw data energy are then fed to a post-processing stage, where the actual voice or digital data is extracted. Currently, the high-end signal collection equipment that is used outputs too much information that overwhelms the post-processing capabilities of military units and intelligence organizations (such as the National Security Agency—NSA). This is a significant problem today. The current signal collection equipment floods the signal post-processing pipeline with extraneous and false positive indications of the presence of interesting signals, also known as “false hits.” The sheer amount of signal data that is collected exceeds the abilities of both manpower and computer power to analyze them in a timely manner. The modern military unit or intelligence organization needs tools to filter (quickly and automatically) the extraneous and/or false data before it gets into the post-processing pipeline. This present requirement is critical since currently there are not enough assets to properly monitor all captured signal data.

For example, the NSA currently has a well-documented problem: how to allocate human and computer resources to analyze all the radio communications the agency collects, especially when the vast majority of the communications collected do not impinge upon the national security. The NSA spends hundreds of millions of dollars sifting through endless mountains of data, most of which is eventually discarded. Tools that make the sifting process much more efficient thus not only save money, but also enhance the security of the nation.

The National Security Agencys' Blackbird signal collection systems employ wideband receivers on its front end. The capabilities of the wideband receivers allow the Blackbird to collect many signals from many sources, many more signals than can be analyzed at once. The wideband receivers are extremely capable at collecting signals, and thus almost become part of the data analysis problem. They are so capable that they currently flood the analysis pipeline with extraneous signal “hits”.

This flood of information will only increase in the future as the collection capabilities of the wideband front end increase exponentially. The analysis capabilities of the processing pipeline must also increase exponentially to avoid exacerbating the glut, never mind diminishing it.

This information glut poses a significant threat to national security since the intelligence information ages quickly, and thus as much of the signal data as possible needs to be analyzed in a timely manner. The current glut forestalls this timely analysis.

### BRIEF DESCRIPTION OF THE DRAWINGS

The various advantages of embodiments of the present invention will become apparent to one skilled in the art by reading the following specification and dependent claims and by referencing the following drawings, in which:

FIG. 1 is a block diagram of an example of a conventional signal processing and analysis system;

FIG. 2 is a block diagram of an example of a signal processing and analysis system with geolocation determination capabilities according to an embodiment of the invention;

FIG. 3 is a sketch of an example of a battlefield scenario according to an embodiment of the invention;

FIG. 4 is a drawing of an example of a directional wideband collection system according to an embodiment of the invention; and

FIG. 5 is a drawing of an example of a geolocation calculation scheme according to an embodiment of the present invention.

### DETAILED DESCRIPTION

In the following detailed description, numerous specific details are set forth in order to provide a thorough understanding of the various embodiments of the present invention. It will be apparent to one of ordinary skill in the art that these specific details need not be used to practice various embodiments of the present invention. In other instances, well-known structures, interfaces, and processes have not been shown in detail in order not to unnecessarily obscure various embodiments of the present invention.

Certain embodiments of the present invention add geolocation information as a discriminator to the front end of signal detection systems, thus automatically filtering extraneous signals arriving from geolocations-NOT- of interest to the intelligence organization. Embodiments of the invention are therefore vital to the interests of United States national security in that they allow less information to be collected that is “better” in nature. Thus, the extraction of intelligence is far more efficient than conventional methods.

The geolocation of a source of a signal can be determined in real time by the deployment and use of two or more instances of intelligence systems such as the systems described in the provisional patent applications from which the present application claims priority. Two or more direction-finding wideband systems can be linked to triangulate the source of a signal in real time.

What is needed therefore in order to feasibly analyze the large number of signals detected by modem signal collection systems is a real-time processing filter that discards as many extraneous signals as possible. What is needed is a system that has: 1) the direction finding and short duration signal collecting abilities taught in references such as U.S. Provisional Patent Application Ser. No. 60/600,657 (hereinafter the '657 provisional application) and U.S. patent application Ser. No. 10/829,858, filed on Apr. 21, 2004, incorporated herein by reference, and 2) the ability to identify the specific geographic location of the source of the signal, also in near real time. The user can direct the system to filter out unwanted signals simply by specifying the geographic location of the transmitters of the signals to be analyzed.

Embodiments described herein provide such a system. Simply put, no known solutions autonomously filter short duration signals, transmitted from a specified, and commandable geographic area, in near real-time.

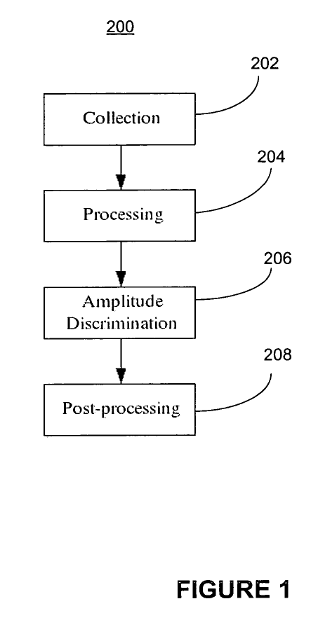

FIG. 1 shows a block diagram an example of a conventional signal collection and analysis system 200. The illustrated system 200 separates the pipeline into four stages: a collection stage 202, a processing stage 204, an amplitude discrimination stage 206, and a post-processing stage 208. Any signals that pass the amplitude discrimination stage 206 are passed directly into the post-processing stage 208. The collection stage 202 contains the radio frequency receiving hardware: antennas, wideband receivers, etc. The processing stage 204 contains one or more hardware logic modules that perform fast fourier transformations (FFTs). The amplitude discrimination stage 206 contains hardware that performs peak detection algorithms to determine the amplitudes of the frequencies received. The post-processing stage 208 contains more computer resources, as well as human resources, to completely analyze the intelligence worthiness of each signal that makes it through this chain.

What is to be noticed is that all signals that pass the amplitude discrimination stage 206 receive post-processing, which occupies both computer and human resources. The presence and amplitude of a signal (so called “energy detection”) are the only discriminators used to choose which signals are post-processed. Thus, there may be an overload of data.

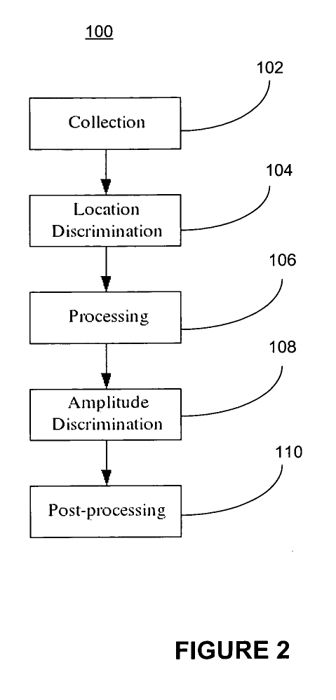

FIG. 2 shows a block diagram of a signal collection and analysis system 100 that has geolocation discrimination capabilities. In the illustrated example, the remaining stages can be similar to the conventional system 200 (FIG. 1) with the addition of the geolocation discrimination stage 104. The geolocation discrimination stage 104 can use a standard triangulation algorithm to determine the geolocation of the source of a signal, given the direction finding (DF) data from all the collection systems.

A few items can be noticed from the figure:
1. The geolocation determination stage/algorithm 104 adds a new discriminator besides presence and amplitude of a signal, so that many more signals will be discarded rather than enter the post-processing pipeline.
2. The geolocation algorithm determines whether to discard a signal or not before any significant processing takes place. This discrimination of geolocation at such an early stage is unique to this invention.
3. Because the signals outside the areas of interest are discarded so quickly, the overall efficiency of the whole pipeline is maximized. Both human and computer resources are used much more efficiently.

The capabilities of this invention thus solve the overload problem mentioned above by discriminating signals by the geolocation of their transmission.

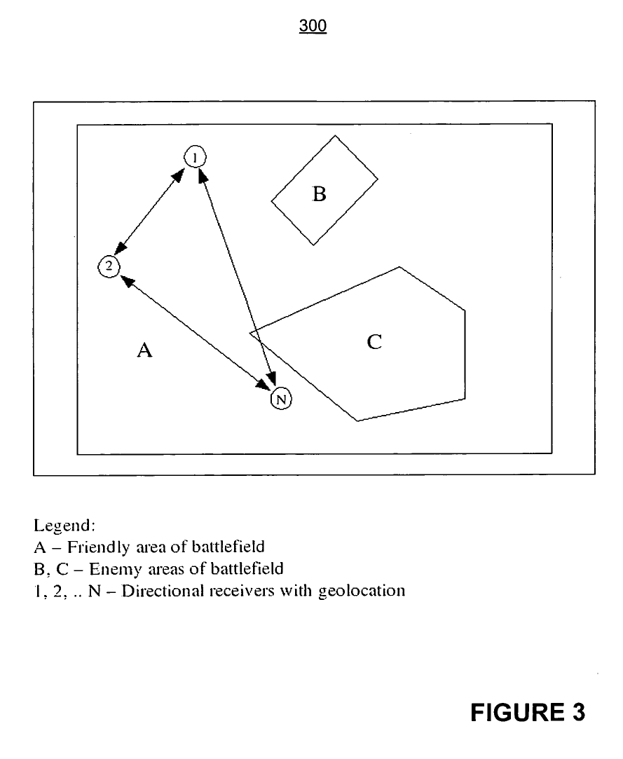

FIG. 3 shows a battlefield scenario 300 with three deployed directional wideband collection systems, along with outlined areas of interest. The battlefield area contains the geolocation of three directional collection systems, along with the geolocations of areas that the user would like to monitor. The directional collection systems are numbered 1, 2, and N; each with directional signal collection capability and geolocation algorithms as described below. Area A is an area on the battlefield or map area where friendly forces are, all such transmissions emanating from Area A should-not-be collected and processed. Areas B and C are areas on the map, selected by the user, where communications coming from those regions should be automatically collected, processed, and even analyzed if possible. In this scenario 300, any of the three areas A, B, and C could be selected to be monitored by the user of the signal intelligence system. The user could monitor the entire battlefield (area A), but usually that would involve swamping the post-processing pipeline with all friendly communications along with the enemy communications. So if enemy transmitters were transmitting from area B or area C, or both, then the monitoring system user could indicate the geographic coordinates of those areas for the system to selectively monitor. The system would then monitor signals transmitted from only areas B and C. Any friendly transmissions from areas outside of B and C would be quickly and automatically ignored and not processed further.

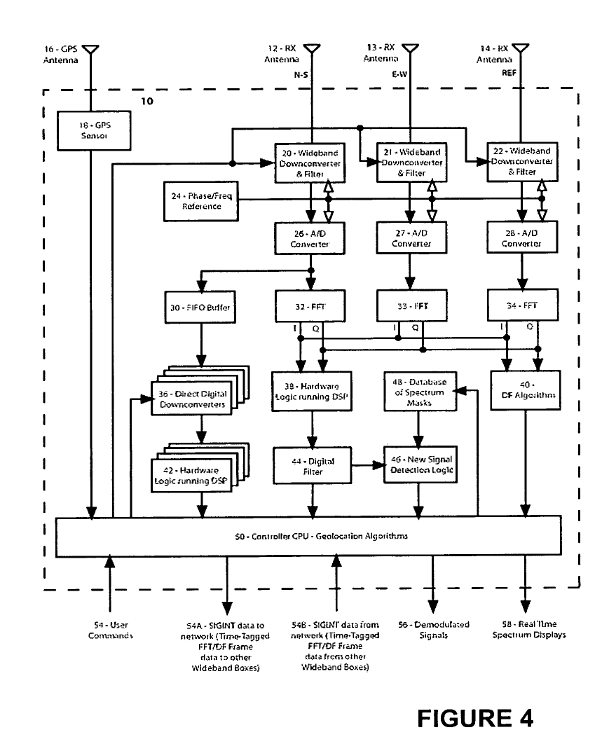

FIG. 4 outlines a more detailed block diagram of an intelligence system 10 according to an embodiment of the invention. The illustrated system 10 may be implemented in hardware, in real-time, without any human intervention. The system 10 adds geolocation determination capabilities to the '657 provisional application by using triangulation, and can therefore replicate the hardware of the '657 provisional application into two or more separate receiving locations.

Another section of the system 10 combines the signal intelligence data received from other peer collection systems. This section contains the selection logic that automatically determines whether or not the received signal should be discarded, based on the geographic location of the source of the signal. The part of the logic section most relevant to the present application is the geolocation algorithm module that calculates the geolocation of the received signals. The method by which the time-tagged FFT/DF frame data is forwarded around by the various boxes is also relevant.

A couple items to notice:
1. The geolocation discrimination algorithm is native to the front-end of the process; it is part of the signal flow just after signal collection. This is not true of conventional systems.
2. Every single frequency point in the capture bandwidth of the front end receivers can be simultaneously analyzed for geolocation of its source. This is not possible with conventional methods and is unique in that the geolocation for every single frequency measurement is calculated.

This system 10 is unique since no other device has the capability or performance to perform these operations, and in real-time.

### DIAGRAM REFERENCE NUMERALS

10 Wideband Collection System with DF/Geolocation Capability
12, 13, 14 Receiving Antennas
16 GPS Antenna
18 GPS Receiver
20, 21, 22 Wideband Downconverters and Filters
24 Phase/Frequency Reference
26, 27, 28 Analog-to-Digital Converters (A/D)
30 FIFO Buffer
32, 33, 34 Fast Fourier Transformations (FFT's)
36 Direct Digital Downconvertors
38 Hardware Logic DSP
40 DF Algorithm
42 Hardware Logic DSP
44 Digital Filter
46 New Signal Detection Logic
48 Database of Spectrum Masks
50 Controlling CPU
52 User Commands
54A SIGINT Output (Time-Tagged FFT/DF Frame Data) to peer collection systems
54B SIGINT Input (Time-Tagged FFT/DF Frame Data) from peer collection systems
56 Demodulated Signals
58 Real-time Spectrum Displays

### OPERATION

Embodiments of the present invention add geolocation determination capabilities to the functionality of conventional solutions. Adding geolocation determination capabilities to conventional solutions may involve three changes: the addition of user commands that specify the signal source areas of interest, the replication of the direction-finding signal collection box hardware, and the addition of dedicated hardware or software that implements a geolocation determination algorithm.

The additional user command can specify the geographic coordinates of the areas of interest. For ease of use, the system operator may be given a map display to indicate the (possibly multiple) areas required. The operator can use the map display to pick out the corners of the area, or areas, of interest.

To add geolocation determination capabilities to the hardware used in conventional approaches an array of two or more collection systems can be deployed. These systems may be connected with a high-speed data link to share signal intelligence information, including FFT bin arrays and direction information about the signals received.

Each directional wideband collection system can behave similarly to the system described in the '657 provisional application down through the direction-finding algorithm 40. After the direction-finding algorithm 40 has determined the direction for each received signal, the FFT bin array and signal directions can be passed to the CPU 50. The illustrated CPU 50 gets a timestamp from the GPS receiver 18, timestamps the FFT bin array and sends the array over the high-speed data link 54A (fiber optic or wireless) to the other peer collection systems.

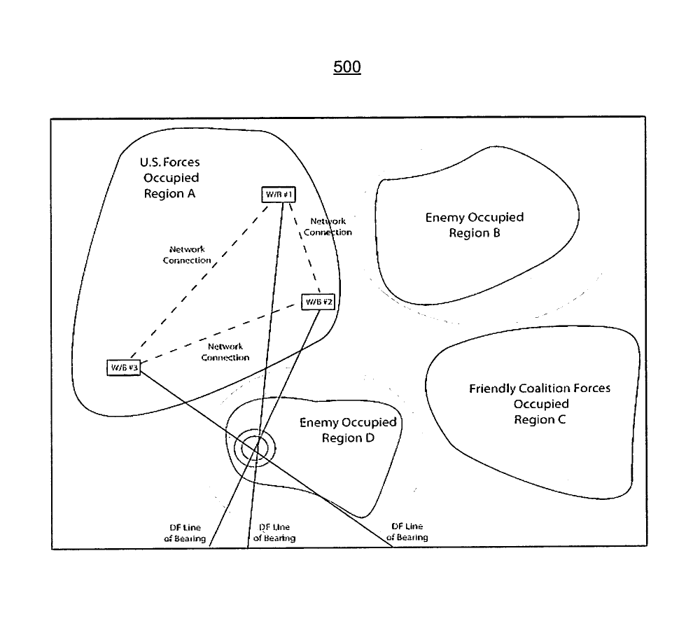

In particular, FIG. 5 shows how embodiments of the invention may actually be put into service. In the illustrated example, several directional wideband collection boxes are distributed and trading their FFT/DF frame data to each other. The geolocation calculations are then processed within each and every wideband collection system box. Subsequently, the wideband collection system box then uses that geolocation information as a discriminant for signal collection purposes.

Returning now to FIG. 4, once the illustrated CPU 50 receives a FFT bin array from the high-speed data link 54B, it checks to see if the timestamp matches previously-received bin arrays. If the CPU 50 finds matching timestamps, it will send all matching bin arrays with their directions to the geolocation algorithm. The geolocation algorithm can determine the geolocation of the source of the signals in the FFT bins from their directions. If the geolocation lies within an area of interest, the signal may be passed on for subsequent recording and analysis. If the geolocation falls outside all areas of interest, the bins are discarded and no action is taken to collect or demodulate the signal.

Again, the operation of the system from the controlling CPU 50 through the output of the data from the directional wideband signal collection box 10 is the same as described in the '657 provisional application.

### SUMMARY

The continuing development of wideband radio frequency receivers for collecting vast amounts of signal intelligence data magnifies the complexities of back-end post-processing pipelines to analyze all the data. There is an urgent need in the U.S. and foreign military and intelligence communities to create systems that can collect signals in more intelligent ways. The problem is the overflow of information that is output from present-day signal collection systems.

Wideband receiver technology today is advancing rapidly, allowing many more signals to be captured and collected, much faster than ever before. A fundamental change in signal intelligence processing efficiency is needed for the modem military force or intelligence organization to avoid being swamped by such a massive glut of information. The modem military force or intelligence organization needs the capability to analyze signal data in a timely manner, no matter how much data is captured and collected.

Embodiments of the present invention provide signal filtering capabilities based on geographic areas of interest, so that most signal data can be discarded quickly if it does not originate from the areas of interest. Such a system is unique in the number and type of input parameters it uses to allow the operator to tailor its filtering results, and solves the efficiency issues of prior art systems. Such a system also greatly enhances the operational capabilities of the modern intelligence organization, by allowing the organization to filter many extraneous collected signals. Certain embodiments rely only on the addition of geolocation determination methods so that short duration signals can be captured and their sources located simultaneously.

The intelligence collection system could have all the abilities of the system described in the '657 provisional application. Secondly the preferred system can automatically detect the geographic location of the source of the incoming signals, to add that information to the filtering decision logic. Finally, the system should provide a user interface so that operators can set up the system to filter signals based upon the geolocation of their source, thereby enhancing efficiency in the analysis processing and post-processing pipeline.

Those skilled in the art can appreciate from the foregoing description that the broad techniques of the embodiments of the present invention can be implemented in a variety of forms. Therefore, while the embodiments have been described in connection with particular examples thereof, the true scope of the embodiments of the invention should not be so limited since other modifications will become apparent to the skilled practitioner upon a study of the drawings, specification, and following claims.

What is claimed is:

1. A local intelligence system comprising:
a front end to generate digital data based on received RF signals;
a post-processing stage to process the digital data; and
a geolocation module to prevent the post-processing stage from processing a first portion of the digital data that corresponds to RF signals originating from a geographic location other than a predetermined geographic location.

2. The local intelligence system of claim 1, wherein the geolocation module is to identify a second portion of the digital data that corresponds to RF signals originating from the predetermined geographic location based on remote geolocation data from one or more remote intelligence systems and local geolocation data.

3. The local intelligence system of claim 2, further including a network input to receive the remote geolocation data, the remote geolocation data to include a remote frequency bin array having a signal arrival direction for each bin in the array and a time stamp.

4. The local intelligence system of claim 2, further including a global positioning system (GPS) receiver, the local geolocation data to include a local frequency bin array having a signal arrival direction for each bin in the array and a time stamp, the GPS receiver to generate the time stamp for the local frequency bin array.

5. The local intelligence system of claim 2, wherein the geolocation module includes a triangulation module.

6. The local intelligence system of claim 1, further including a user input to receive an indication of the predetermined geographic location.

7. The local intelligence system of claim 6, wherein the user input includes a map display in which the predetermined geographic location is to be identified by selecting a plurality of points on the map display.

8. A method of collecting intelligence comprising:
generating digital data based on received RF signals; and
preventing a first portion of the digital data that corresponds to RF signals originating from a geographic location other than a predetermined geographic location from being processed.

9. The method of claim 8, further including identifying a second portion of the digital data that corresponds to RF signals originating from the predetermined geographic location based on remote geolocation data from one or more remote intelligence systems and local geolocation data.

10. The method of claim 9, further including receiving the remote geolocation data at a network input, the remote geolocation data including a remote frequency bin array having a signal arrival direction for each bin in the array and a time stamp.

11. The method of claim 9, further including generating a time stamp, the local geolocation data to include a local frequency bin array having a signal arrival direction for each bin in the array and the time stamp.

12. The method of claim 9, further including identifying the second portion of the digital data based on a triangulation algorithm.

13. The method of claim 8, further including receiving an indication of the predetermined geographic location at a user input.

14. The method of claim 13, wherein the receiving includes detecting a user selection of a plurality of points in a map display.
